(19) United States
(12) Patent Application Publication
(10) Pub. No.: US 2006/0153352 A1
(43) Pub. Date: Jul. 13, 2006

(54) COMMUNICATION SYSTEM

(75) Inventors: Holger Schmidt, Braunschweig (DE); Martin Hans, Hildesheim (DE); Mark Beckmann, Braunschweig (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/142,007

(22) Filed: May 31, 2005

(30) Foreign Application Priority Data
Jun. 2, 2004 (DE) 10 2004 026 785.5

(51) Int. Cl. H04M 3/42

(52) U.S. Cl. 379/202.01

(57) ABSTRACT

A communication system having a conference server and a conference control unit to which a call control protocol message is transmitted which specifies whether a communication terminal needs to be added to a conference, and/or a conference needs to be created, and/or a conference needs to be terminated, and/or information about at least one of the conferences provided by the conference server needs to be transmitted to a communication terminal.

The invention relates to a communication system, a communication terminal, a conference control unit, a method for controlling the communication system, a method for controlling a communication terminal and a method for controlling a conference control unit.

The 3rd Generation Partnership Project (3GPP) has developed a standard for the “Internet Protocol Multimedia Core Network Subsystem (IMS) architecture”.

An IMS, that is to say a communication network based on this IMS standard developed by the 3GPP, allows various communication services to be provided for a mobile terminal on the basis of the Internet Protocol (IP).

Examples of such communication services are the Voice over Internet Protocol (VoIP), video telephony and conferencing, for example teleconferencing.

In accordance with IMS, data transmission for the communication services is based on the Internet Protocol. This means that it is possible to provide communication services using all packet-based communication systems, for example a Wireless Local Area Network (W-LAN), the GPRS (General Packet Radio Service) and the UMTS (Universal Mobile Telecommunications System).

In particular, an IMS allows a multiplicity of communication services to be made accessible to a broad user base.

The (IMS) conference service will have not only a method for allocating rights (floor control) and setting up conference rules (conference policy control protocol) but also procedures which are based on the SIP (Session Initiation Protocol); inter alia, it will provide procedures for creating, managing, terminating, joining and leaving multimedia conferences.

In addition, the conference service will provide methods for notifying the conference participants about specific information and events relating to the conference.

Within the context of this conference service, it is possible for the participants in a conference to exchange media of different types.

By way of example, it is possible to provide audio conferences, video conferences, instant messaging conferences, that is to say chat conferences, for example, and gaming conferences.

[1] describes a star-shaped conference architecture for a communication system, in which conference architecture all conference participants are coupled to a conference control program, which controls the conference and which is executed on a “(conference) focus”, by means of signaling connections. The focus thus represents a logic unit in the IMS.

A particular conference which is associated with a particular focus, that is to say is controlled and executed by said focus, has an associated conference address, which in this case is referred to as C-URI (Conference Uniform Resource Indicator).

The conference address represents the conference, and a user of the communication system can use the conference address to join the conference, for example.

The focus has access to the conference rules (conference policy), inter alia, which are managed by a CPS (Conference Policy Server).

Besides implementing the conference rules, the focus has the task of providing for the conference-specific distribution of the media contents to the conference participants.

To this end, the focus uses “mixers”, which are controlled by means of the focus on the basis of the media rules (media policy), which are part of the conference rules, and which perform the individual compilation and the distribution of the media contents to the conference participants.

[2] specifies a method for creating a conference and for joining a conference using the address of the focus, said address also being referred to as conference URI or C-URI below.

This method has the risk of a collision when ranges of conference addresses are reserved.

This is manifested such as a user wishing to create a new conference is possibly added to an already existing conference instead of a new conference being created, as is explained in more detail below.

To create a conference, [2] specifies two SIP procedures, that is to say two procedures based on the SIP.

In line with the first method, the user who wishes to create a conference sends an “SIP INVITE” message, as described in [3], to the conference factory URI.

The conference factory URI is the address of a conference server, that is to say a server which is able to create and manage conferences with an associated focus.

In line with [4], successful setup of an SIP session with the conference server results in the creation of a focus, a C-URI associated therewith and hence a conference.

In line with the second method for creating a conference which is specified in [2], a previously reserved C-URI is used.

For a reserved C-URI, a focus associated with this address also exists in this case. To create a conference, the user uses the C-URI to send an “SIP INVITE” message, as above, in this case directly to the focus.

In line with [2], when this message has been received, a conference is created if it does not already exist. This reserves and subsequently enables the resources required for a conference.

If a user wishes to join an already existing conference, the user or the terminal he is using likewise sends an “SIP INVITE” message to the C-URI. When it has received this message, the focus associated with this C-URI adds the user to the already existing conference specified by means of the C-URI.

From the point of the user, there is no difference between the method for creating a conference and the method for joining a conference (cf. [2]).

For the focus, there is a difference in that it activates a reserved conference or adds a user to an existing conference.

It is possible, as described in [4] too, for entire address ranges to be reserved for conferences, for example a full domain (for example conf.vodafone.com) or subdomains (for example the address range from conference1@conf.vodafone.com to conference9999@conf.vodafone.com.).

This reserved address ranges may be used for conferences.

In this case, collisions may arise, however. If a conference with a specific C-URI (for example conference666@conf.vodafone.com) has already been activated, that is to say created, by a user then the attempt by another user to create a conference with the same name or C-URI results in this user being added to the conference which already exists under this name or address.

In this way, collisions arise between conference creation and joining an existing conference.

Furthermore, there is no method for requesting the conferences managed and provided by a conference server using SIP-based procedures.

In addition, in line with the current specification of the IMS conference service (see [2]), it is not possible to distinguish, using the “SIP INVITE” message, whether a conference participant wishes to leave a conference or whether he wishes to terminate the entire conference.

Termination of a conference by a user would mean that all participants are removed from the conference. This is synonymous with clearing the signaling connection (SIP session) between the conference participants and the focus.

In line with the prior art described in [2], a conference is not terminated until all participants have left the conference, however. This is disadvantageous particularly when a user has created a conference and accepts the costs for this conference but cannot ensure that when he leaves the conference the conference is actually terminated.

[1], [2] and [4] have described a method for terminating the participation of a user in a conference using SIP messages.

To this end, the SIP dialog and hence the SIP session between the conference participant and the focus are terminated using an “SIP BYE” message.

In this way, as was mentioned above, it has hitherto been possible only to terminate an individual conference participant's participation in a conference, but the conference generally continues to exist when there are still further participants in the conference.

Although it is generally possible to prescribe an appropriate conference rule (conference policy) stating that the entire conference is terminated as soon as a particular participant has left the conference, there is no known SIP-based method for terminating a conference (cf. see [1]).

This opportunity to terminate a conference using a conference rule presupposes that the user creating the conference is able to influence the conference rules or that these conference rules are initialized with suitable standard values.

In line with the IMS standard, this is not so in all cases, however.

In line with [2], support for the CPCP (Conference Policy Control Protocol), that is to say the protocol for manipulating the conference rules, is only optional.

Even if a user supports this protocol, that is to say that the protocol is implemented in the communication terminal which the user is using, he can, in principle, use the CPCP in line with the IMS-Rel-6-architecture only if the conference has been created in his H-PLMN (Home Public Land Mobile Network), that is to say in his home network.

Generally, a conference is thus terminated only when, as mentioned above, all participants in the conference have left the conference.

It is particularly disadvantageous not only for tariffing reasons, as described above, when a user is paying for the conference but also in respect of the completeness of the SIP procedures and of the SIP functionality within the IMS's conference service.

[5] describes a method which a user, or the UAC (User Agent Client) used by the user, can use to indicate preferences for how to handle his/its request.

In this context, a distinction can be drawn between two types of preferences.

Preferences of the first type are called “request handling preferences” and give the server special instructions regarding how to handle the request.

By way of example, these instructions indicate that the request needs to be simultaneously routed to different contact addresses and hence communication terminals belonging to a subscriber called by the user, which is referred to as “forking”, or that the different contact addresses need to be contacted in succession, which is referred to as “search sequentially”.

In this case, the instructions are transmitted in the message header field (header) labelled “Request Disposition” for an SIP request.

Preferences of the second type are called “feature preferences” and allow the user sending an SIP request to indicate a set of features which describes which properties the called participant's UA (User Agent) needs to have.

A communication terminal with SIP capability which sends SIP requests and responds to requests with SIP responses is called an SIP UA (User Agent). A UA thus has a UAC (User Agent Client), which can send requests, and a UAS (User Agent Server), which can respond to requests. In the text below it is assumed that each communication terminal contains a UA.

To transmit feature preferences, the message header field labelled “Accept Contact” and the message header field labelled “Reject Contact” are used.

The properties or the feature preferences are indicated using “feature tags”, that is to say using particular tags in said message header fields.

[6] specifies various base tags.

Within the context of the IETF standard, it is permissible to define further tags, however.

In line with [5], the indicated properties can be evaluated both by a special SIP server, the SIP registrar, with which users wishing to use the IMS register, and by a UAS itself.

A UA can transmit its properties to the SIP registrar or to another UA using the parameters in the message header field labelled “Contact Header”.

While a session is being set up, the SIP registrar is thus able to compare the properties demanded by a calling user with the properties of the UA associated with each contact address of the called user.

Next, that UA (and the corresponding contact address) whose properties best match the properties demanded by the calling user is selected.

The calling user's request is forwarded to this contact address.

[1], [2] and [4] use this method to indicate that a UA is a focus. In this regard, the UA adds the feature tag (indicated in [6]) labelled “isfocus”, which is a base tag, as a parameter to the Contact Header message header field of an SIP message transmitted to another UA. The other UA, which receives the SIP message with the corresponding “contact header”, recognizes that the UA which has sent the SIP message is a focus and has corresponding functions.

[7] describes the “SIP REFER method”, which can be used, as also described in [1] and [2], by a conference participant to ask a focus to send an SIP message, for example a BYE message or an INVITE message, as will be described below, indicated within a REFER message to an address indicated in the REFER message, e.g. in the form of a SIP URI.

Using the SIP REFER message, a conference participant may ask the focus, for example, to send an SIP INVITE message to a particular user or to his UA. In this way, this user is asked to join the conference.

The user is thus being invited by the conference participant who sent the REFER message to the focus.

[8] describes the architecture and the procedures of the IMS (stage 2).

[9] describes a conference management program which provides a service for conditionally terminating conferences.

[10] describes the setup of a telephone conference between at least three subscribers, where, when a subscriber in a telecommunication network requests a telephone conference, subscribers stored in a list together with the subscriber requesting the telephone conference are connected together by means of a bridge to produce a telephone conference.

The invention is based on the problem of avoiding collisions when creating conferences and when joining conferences, of allowing information about the conferences managed by a conference server to be requested, and of allowing a conference to be terminated by a user using SIP messages.

The object is achieved by a communication system, a communication terminal, a conference control unit, a method for controlling a communication system, a method for controlling a communication terminal and a method for controlling a conference control unit having the features based on the independent patent claims.

The invention provides a communication system which has a conference server, a conference control unit and at least one communication terminal, where the conference server is set up to provide at least one conference for a plurality of communication terminals; the at least one communication terminal has a message generation unit which is set up to generate a call control protocol message, which call control protocol message contains control information specifying whether the at least one communication terminal needs to be added to a conference and/or a conference needs to be created and/or a conference needs to be terminated and/or information about at least one of the conferences provided by the conference server needs to be transmitted to the at least one communication terminal; the conference control unit has an ascertainment apparatus which is set up to ascertain the control information from the message; the conference control unit has a control apparatus which is set up to take the ascertained control information as a basis for adding the at least one communication terminal to a conference and/or creating a conference and/or terminating a conference and/or transmitting information about at least one of the conferences provided by the conference server to the at least one communication terminal.

In addition, a communication terminal, a conference control unit, a method for controlling a communication system, a method for controlling a communication terminal and a method for controlling a conference control unit in line with the communication system described above are provided.

In one embodiment, the conference control unit realizes a focus.

In another embodiment, the conference control unit is part of the conference server.

Clearly, the invention can be seen in that the signaling options permissible in line with standards for communication systems, for example the IETF or 3GPP standard, are used or are expanded as permitted within the context of the standard in order to achieve a new functionality in comparison with the standard.

The invention can be used, in particular, to resolve the collision described above between creating a new conference and joining an existing conference, since the control information is used to specify whether the user wishes to participate in an existing conference or wishes to create a new conference.

It is also possible to request information about the conferences managed by a conference server using a communication terminal.

It is also possible for a user to terminate a conference, and particularly for the user to explicitly order the termination of a conference. This functionality is particularly important when the user is the creator of a conference and has to pay for the conference on a time basis.

Preferred developments of the invention can be found in the dependent claims. The further refinements of the invention which are described in connection with the communication system provided also apply, in an appropriate sense, to the communication terminal provided, to the conference control unit, to the method provided for controlling a communication system, to the method provided for controlling a communication terminal and to the method provided for controlling a conference control unit.

It is preferred for the call control protocol message to be designed on the basis of the SIP protocol.

In this case, a conference which is provided involves communication between a plurality of communication terminals interchanging various data, for example in the form of a chat or video streaming. The total quantity of media streams which have been set up using the SIP protocol is also referred to as a multimedia session.

In one embodiment, the control information is contained in the call control protocol message in the form of a feature tag.

In one embodiment, the communication system is configured in line with a 3GPP standard.

In one embodiment, the feature tag is a feature tag provided in the IETF standard or 3GPP standard.

In a further embodiment, the feature tag is a feature tag which is newly defined in comparison with the IETF standard or in comparison with the 3GPP standard.

By way of example, a feature tag which is new in comparison with the IEFT and the 3GPP standard, for example labelled “Join” or “Create”, is used to resolve the collision when creating a conference and to join an already existing conference.

In another exemplary embodiment, a feature tag which is new in comparison with the IETF or the 3GPP standard, for example labelled “Terminate” or “Continue”, is used to distinguish whether a conference participant wishes to leave or terminate the conference.

In another exemplary embodiment, a feature tag which is new in comparison with the IETF or the 3GPP standard is used for implicitly requesting information about the conferences managed by a conference server.

Preferably, the feature tag is contained in the Accept-Contact message header field or in the Reject-Contact message header field of the call control protocol message.

By way of example, to resolve the collision when creating a conference and to join an already existing conference, the communication terminal generates a message which contains the isfocus feature tag (provided in line with the IETF or 3GPP standard) in the Accept-Contact message header field or in the Reject Contact message field.

In another exemplary embodiment, the isfocus feature tag in the Accept Contact message header field or in the Reject Contact message header field is used to distinguish whether a conference participant wishes to leave or terminate the conference.

It is preferred for the control information to be contained in the call control protocol message in the form of a reference.

By way of example, to signal that a conference needs to be terminated, the communication terminal generates an SIP REFER message and sends it to the C-URI, said message containing the C-URI of the conference which is to be terminated and the character string “method=BYE” in the Refer To message header field.

It is also preferred for the reference to have at least one wildcard.

By way of example, to signal that a conference needs to be terminated, the communication terminal generates a REFER message and sends it to the C-URI, said message containing wildcards (e.g. “*” or “?”) and the character string “method=BYE”, so that the Refer To message header field in the REFER message is used to reference all communication terminals with addresses from a particular address range. In this way, an indication is given that these referenced communication terminals are not intended to participate further in a conference which is to be terminated. This results in the implicit termination of the conference given a suitable choice of address range.

Clearly, the effect of sending a message which contains a reference with wildcards to the focus is that a message corresponding to the value of a parameter “method”, for example a BYE message, is sent to all communication terminals participating in the conference, which instructs the communication terminals to leave the conference and hence implicitly terminates the conference.

In another embodiment, the conference server itself is referenced by means of the Refer To message header field, which instructs it to terminate the conference.

Preferably, the reference has one or more parameter values.

By way of example, to signal that a conference needs to be terminated, the communication terminal generates a REFER message which, besides the indication of the C-URI in the Refer To message header field, contains the value “BYE” for the parameter “method” using the character string “method=BYE”, and also contains an additional parameter in the form of a character string, for example “terminate”.

Preferably, the reference is contained in the Refer To message header field.

In one alternative embodiment, the call control protocol message is designed in line with the H.323 protocol.

It is preferred for the at least one conference provided by the conference server to be a multimedia conference, for example an audio conference, a video conference, an instant messaging conference, e.g. a chat conference, or a gaming conference.

Exemplary embodiments of the invention are illustrated in the figures and are explained in more detail below.

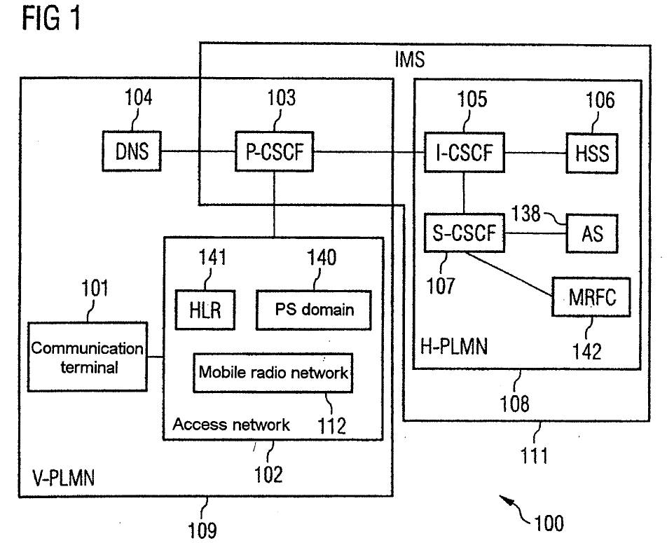

FIG. 1 shows a communication system based on an exemplary embodiment of the invention;

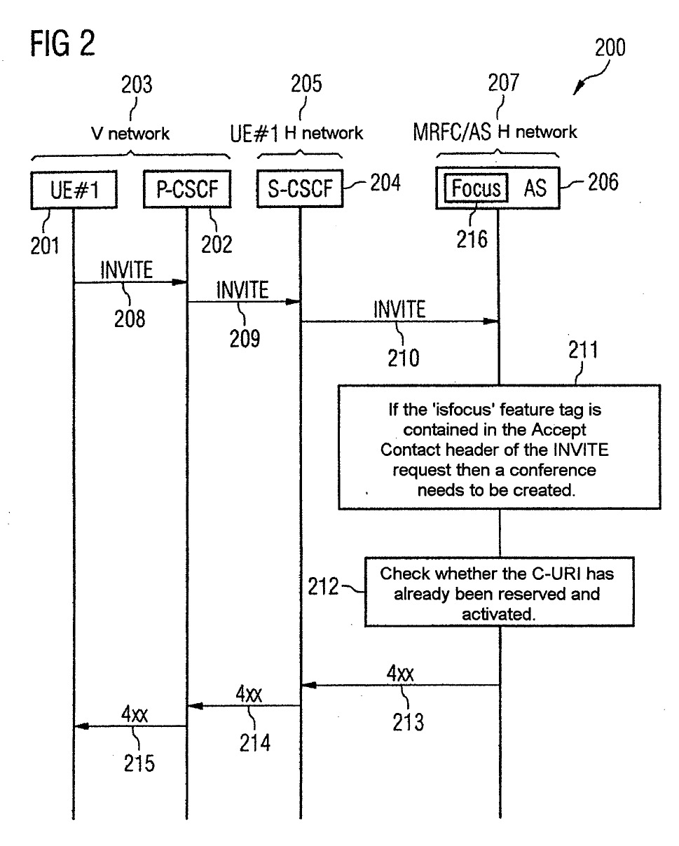

FIG. 2 shows a message flowchart based on an exemplary embodiment of the invention;

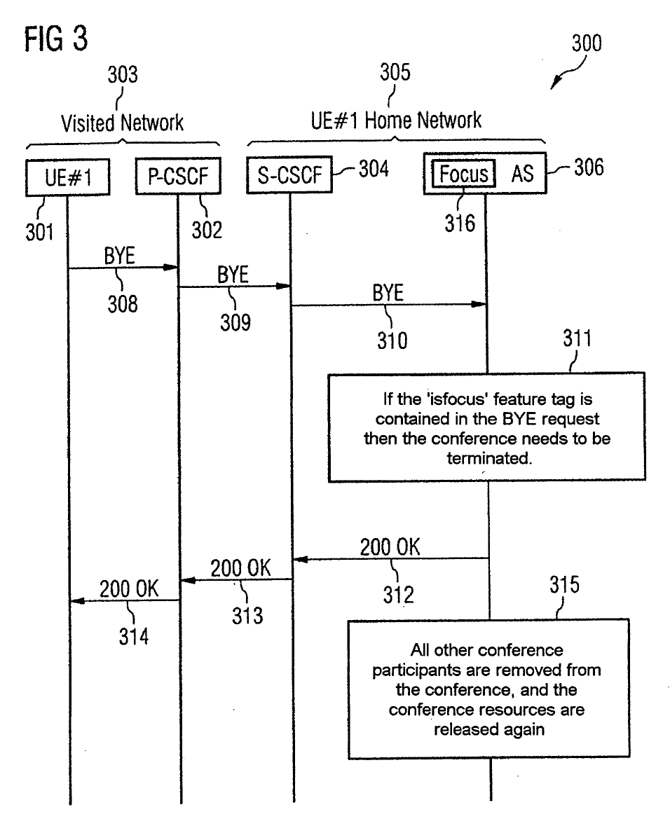

FIG. 3 shows a message flowchart based on an exemplary embodiment of the invention;

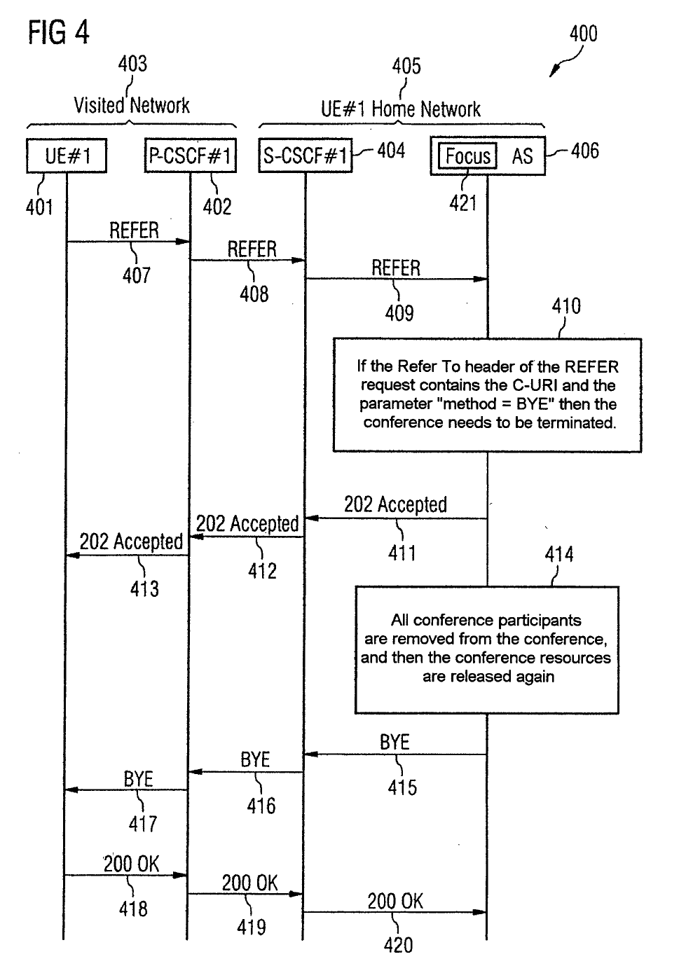

FIG. 4 shows a message flowchart based on an exemplary embodiment of the invention.

FIG. 1 shows a communication system 100 based on an exemplary embodiment of the invention.

The communication system 100 is designed in line with the UMTS architecture described by 3GPP, the integral component of said UMTS architecture being the IMS, see [8], for example.

A communication terminal 101 is coupled to an IMS 111 by means of an access network 102.

The access network 102 may be a mobile radio communication network based on the UMTS standard, for example, i.e. a Universal Terrestrial Access Network allowing the communication terminal to access the IMS 111 using a packet switched domain or an access network based on the GSM standard, i.e. a GSM EDGE radio access network.

The access network 102 may also be a landline network, for example the communication terminal 101 may have an apparatus which permits access to the internet, for example a DSL (Digital Subscriber Line) modem. In this example, the communication terminal is coupled to the IMS 111 by means of the internet.

In accordance with the refinement of the access network 102, the communication terminal 101 is a mobile telephone or a computer with or without a mobile radio module, for example.

In this exemplary embodiment, the access network 102 is a mobile radio communication system based on the UMTS communication standard.

A mobile radio network 112 in the access network 102 has the architecture of a UMTS radio network, which is also referred as a UMTS terrestrial radio access network (UTRAN).

The access network has a PS domain 140 which comprises the components SGSN (Serving GPRS Support Node), GGSN (Gateway GPRS Support Node) and forms the interface for packet-switched connections between the mobile radio network 112 and external packet-based data networks, such as the internet, and provides access to the IMS 111.

Accordingly, the PS domain 140 performs all functions to ensure the transport of packet-switched data. In addition, it allows signaling messages to be transported to the IMS.

The access network also has an HLR 141, which is a central database storing all of the subscriber information required to set up connections and to manage services, in particular.

The access network 102 couples the communication terminal 102 to a P-CSCF (CSCF: Call Session Control Function, P-CSCF: Proxy-CSCF) 103 in the IMS 111.

The P-CSCF 103 serves as an exchange and is coupled to a DNS (Domain Name Server) 104 and to an I-CSCF (Interrogating CSCF) 105.

The I-CSCF 105 is coupled to an HSS 106 (Home Subscriber Server) 106 and to an S-CSCF (Serving CSCF) 107.

The S-CSCF 107 is coupled to a plurality of application servers, only one application server 138 of which is shown.

The S-CSCF 107 is also coupled to an MRFC (Media Resource Function Controller) 142.

The application server 138 and the MRFC 142 are used to provide a conference server and at least one focus.

The communication terminal 101, the access network 102, the P-CSCF 103 and the DNS 104 are parts of the visited network (V-PLMN) 109.

The I-CSCF 105, the HSS 106, the S-CSCF 107 and the application server AS 138 are parts of the home communication network (H-PLMN) 108.

The P-CSCF 103, the I-CSCF 105, the HSS 106 and the S-CSCF 107 are a part of the IMS (IP Multimedia Core Network Subsystem) 111, as described in [8], for example.

Using the communication terminal 101, a user can use the communication services of the IMS 111, for example can send an “instant message” to another communication terminal coupled to the communication system 100 or can hold a conference with users of other communication terminals coupled to the communication system 100.

FIG. 2 shows a message flowchart 200 based on an exemplary embodiment of the invention.

The message flow shown in FIG. 2 takes place between a communication terminal 201, a P-CSCF 202, which are part of a visited network 203, a S-CSCF 204, which is part of the home network of the communication terminal 205, and an application server 206, which is part of the home network of the application server 207. The application server is seen below in combination with an MRFC.

In this exemplary embodiment, the application server 206 has the function of a conference server and of at least one focus.

The exemplary embodiment described with reference to FIG. 2 is used to resolve the above-described collision between creating a conference using a C-URI and joining an already existing conference using a C-URI.

In step 208, the user of the communication terminal 201 uses the communication terminal 201 to send an SIP “INVITE” message using the P-CSCF 202 to the C-URI and hence to the AS 206. In this case, the INVITE message is routed to the AS 206 in the subsequent steps using the network elements shown.

The INVITE message is in the form shown in table 1.

TABLE 1
(SDP (Session Description Protocol) not shown)

INVITE sip:conference666@mrfc2.home2.net SIP/2.0
Via: SIP/2.0/UDP [5555::aaa:bbb:ccc:ddd]:1357;
comp=sigcomp;branch=z9hG4bKnashds7
Max-Forwards: 70
Route: <sip:pcscf1.visited1.net:7531;lr;comp=sigcomp>,
<sip:orig@scscf1.home1.net;lr>
P-Preferred-Identity: “Holger Schmidt”
<sip:user1_public1@home1.net>
P-Access-Network-Info: 3GPP-UTRAN-FDD; utran-cell-id-
3gpp=234151D0FCE11
Privacy: none
From: <sip:user1_public1@home1.net>; tag=211172
To: <sip:conference666@mrfc2.home2.net>
Call-ID: cb03a0s09a2sdfglkj490333
Cseq: 127 INVITE
Require: precondition, sec-agree
Proxy-Require: sec-agree
Supported: 100re1
Security-Verify: ipsec-3gpp; q=0.1; alg=hmac-sha-1-96;
spi-c=98765432; spi-s=87654321; port-c=8642; port-s=7531
Contact: <sip:[5555::aaa:bbb:ccc:ddd]:1357;comp=sigcomp>
Allow: INVITE, ACK, CANCEL, BYE, PRACK, UPDATE, REFER,
MESSAGE
Accept-Contact: isfocus
Content-Type: application/sdp
Content-Length: (. . .)

In particular, the INVITE message has a message header field labelled “Accept Contact”, and the “isfocus” feature tag is set (see row 18 from table 1).

In step 209, the P-CSCF 202 uses the C-URI indicated in the INVITE message (see row 9 from table 1) to forward the INVITE message to the S-CSCF 204.

In step 210, the S-CSCF 204 uses the C-URI indicated in the INVITE message to forward the INVITE message to the application server 206, which provides the indicated focus 216 corresponding to C-URI.

In step 211, the focus 216 checks whether the INVITE message has the isfocus feature tag.

If the INVITE message does have the isfocus feature tag, the focus 216 is instructed to create or activate a conference corresponding to the indicated C-URI.

If the INVITE message does not have the isfocus feature tag, the focus 216 is instructed to add the user to the conference indicated by means of the C-URI.

Since in this example the INVITE message does have the isfocus feature tag, the focus 216 is instructed to activate or create the indicated conference.

The communication terminal 201 thus uses the isfocus feature tag to signal to the focus 216 that it wishes to activate a reserved conference itself and does not wish to be added to an existing conference.

In step 212, the focus 216 checks whether a conference which is associated with it and which corresponds to the C-URI has already been created.

In this example it is assumed that the conference corresponding to the C-URI, which is conference666@mrfc2.home2.net (see table 1), has already been activated by another user beforehand and is therefore already being used.

The focus 216 therefore does not add the communication terminal 201 to the already existing conference, but rather responds to the communication terminal 201 with an error message in the form of an SIP “4xx” message, which is transmitted to the S-CSCF 204 in step 213.

In step 214, the S-CSCF 204 forwards the 4xx message to the P-CSCF 202, which transmits the 4xx message to the communication terminal 201 in step 215.

The communication terminal 201 can now select another C-URI in the address range reserved for conferences in order to create a new conference. The communication terminal 201 can then use this newly selected C-URI to make a new attempt to create and activate a conference.

The use of the isfocus feature tag thus makes it possible to distinguish whether the user wishes to create a conference or wishes to join an already existing conference.

In another embodiment, the communication terminal sets the isfocus feature tag in the Accept Contact message header field when the user wishes to join the conference indicated by means of the C-URI.

In another embodiment, a feature tag which is newly defined in comparison with the standard is defined which is used like the isfocus feature tag, as described above.

By way of example, a “Join” feature tag or a “Create” feature tag is defined, with the communication terminal setting, that is to say adding, the Create feature tag in the Accept Contact message header field when the user wishes to create a conference corresponding to the indicated C-URI and sets the Join feature tag in the Accept Contact message header field when the user wishes to join the conference corresponding to the indicated C-URI.

In another embodiment, the Reject Contact message header field is used instead of the Accept Contact message header field.

As explained above, in line with [5], this message header field is used to specify what properties a UA is intended not to have. The Reject Contact message header field can be used in similar fashion to the Accept Contact message header field, for example if the user wishes to join a conference then the message transmitted in step 208 may be in a form such that it has a Reject Contact message header field in which the isfocus feature tag is set.

In similar fashion, the aforementioned alternatives may be used using the Reject Contact message header field.

When using the Reject Contact message header field, the use of feature tags which are newly defined in comparison with the standard has advantages, since this avoids ambiguities.

The embodiment described with reference to FIG. 2 may, if it is slightly modified, also be used in conjunction with SIP procedures to request information about the conferences managed by a conference server. In this case, the message is sent to the conference factory URI, however.

In the embodiment described below, this is done using a feature tag labelled “Fetch” which is newly defined in comparison with the standard.

The flow of messages in this embodiment is similar to the embodiment described with reference to FIG. 2.

If the INVITE message in the Accept Contact message header field (which message is in this case sent to the application server 206 and not directly to a focus 216 created by the application server 206, as above) has the fetch feature tag, the application server 206 creates a conference and sends the communication terminal (UE) 201 information about the conferences managed by the conference server.

To this end, the message body of a response message from the conference server for the INVITE message is used to transmit information about the conferences managed by the conference server, for example a list of the conferences managed by the conference server.

The response message may be the “200 OK” message, or another response message, for example a provisional response message.

By way of example, the response message may contain the following information about the conferences managed by the conference server:
the address of the respective conference, that is to say the C-URI of the conference,
the URI of the UA which has created the conference
a description of the conference, such as the subject of the conference.

Hence, requesting information about the conferences managed by a conference server is integrated in the procedure for creating a conference.

FIG. 3 shows a message flowchart 300 based on exemplary embodiment of the invention.

The message flow illustrated in FIG. 3 takes place between a communication terminal 301, a P-CSCF 302, which are part of a visited network 303, an S-CSCF 304 and an application server 306, which are part of the home network of the communication terminal 305.

In this exemplary embodiment, the application server 306 is a conference server.

Using the embodiment described below, it is possible to terminate a conference using SIP messages.

In step 308, the user of the communication terminal 301 uses the communication terminal 301 to send a message labelled “BYE”, which contains the indication of an C-URI, to the P-CSCF 302.

The BYE message is in the form shown in table 2. In particular, the BYE message has a message header field labelled “Accept Contact”, and the “isfocus” feature tag is set (see row 11 in table 2).

TABLE 2

Via: SIP/2.0/UDP[5555::aaa:bbb:ccc:ddd]:1357;
comp=sigcomp;branch=z9hG4bKnashds7
Max-Forwards: 70
Route: <sip:pcscf1.visited1.net:7531;lr;comp=sigcomp>,
<sip:orig@scscf1.home1.net;lr>
P-Access-Network-Info: 3GPP-UTRAN-FDD;
utran-cell-id-3gpp=234151D0FCE11
From: <sip:user1_public1@home1.net>; tag=171828
To: <sip:conference-factory1@mrfc1.home1.net>;
tag=314159
Call-ID: cb03a0s09a2sdfglkj490333
Require: sec-agree
Proxy-Require: sec-agree
Security-Verify: ipsec-3gpp; q=0.1; alg=hmac-sha-1-96;
spi-c=98765432; spi-s=87654321; port-c=8642; port-
s=7531
Accept-Contact: isfocus
Cseq: 153 BYE
Content-Length: 0

In step 309, the P-CSCF 302 uses the C-URI indicated in the BYE message (see row 6 from table 2) to forward the BYE message to the S-CSCF 304.

In step 310, the S-CSCF 304 uses the C-URI indicated in the BYE message to forward the BYE message to the application server 306, which provides the focus 316, which provides the conference addressed by means of the C-URI.

In step 311, the focus 316 checks whether the BYE message has the isfocus feature tag.

If the BYE message does have the isfocus feature tag, the focus 316 terminates the conference referenced or addressed by means of the C-URI. In this case, all conference participants are removed from the conference. If the BYE message does not have the isfocus feature tag, the focus 316 removes the use 301 from the conference.

Since in this example the BYE message does have the isfocus feature tag, the focus 316 is instructed to terminate the conference corresponding to the C-URI and to remove all participants from the conference.

In step 312, the focus 316 responds to the communication terminal 301 by means of a message labelled “200 OK”, which is transmitted to the S-CSCF 304.

In step 313, the S-CSCF 304 forwards the “200 OK” message to the P-CSCF 302, which transmits the “200 OK” message to the communication terminal 301 in step 314.

In this example, it is assumed that besides the user who is using the communication terminal 301 there are also other participants in the conference.

Since the BYE message does have the isfocus feature tag in this example, the focus terminates the conference in step 315 by terminating the respective SIP dialogs with the other conference participants.

The use of the isfocus feature tag in the Accept Contact message header field of the BYE message thus allows a distinction to be drawn, in this embodiment, between the case in which the user wishes to terminate his participation in this conference and the case in which the user wishes to terminate the conference, which includes his wishing to terminate his participation in the conference.

As in the case of the embodiment described with reference to FIG. 2, there are various alternatives to the embodiment described with reference to FIG. 3.

In particular, signalling is possible using feature tags which are newly defined in comparison with the standard instead of the isfocus feature tag, in a similar manner to the embodiment described with reference to FIG. 2, for example labelled “Terminate” to indicate that the conference is to be terminated or labelled “Continue” to indicate that the user wishes to leave the conference but that the conference is not to be terminated.

FIG. 4 shows a message flowchart 400 based on an exemplary embodiment of the invention.

The flow of messages illustrated in FIG. 4 takes place between a communication terminal 401, a P-CSCF 402, which are part of a visited network 403, an S-CSCF 404 and an application server 406, which are part of the home network of the communication terminal 405.

In this exemplary embodiment, the application server 406 is a conference server.

The embodiment described below is an alternative to the embodiment for terminating a conference which is described with reference to FIG. 3.

In the embodiment described below, the SIP-REFER method described in [7] is used to terminate a conference.

In step 407, the user of the communication terminal 401 uses the communication terminal 401 to send an SIP “REFER” message containing a C-URI to the P-CSCF 402.

The REFER message is in the form shown in table 3.

TABLE 3

REFER sip:conference666@mrfc1.home1.net SIP/2.0
Via: SIP/2.0/UDP [5555::aaa:bbb:ccc:ddd]:1357;
comp=sigcomp; branch=z9hG4bKnashds7
Max-Forwards: 70
Route: <sip:pcscf1.visited1.net:7531;lr;comp=sigcomp>,
<sip:orig@scscf1.home1.net;lr>
P-Preferred-Identity: “Holger Schmidt”
<sip:user1_public1@home1.net>
P-Access-Network-Info: 3GPP-UTRAN-FDD;
utran-cell-id-3gpp=234151D0FCE11
Privacy: none
From: <sip:user1_public1@home1.net>; tag=171828
To: < conference666@mrfc1.home1.net>
Call-ID: cb03a0s09a2sdfglkj490333
Cseq: 127 REFER
Require: sec-agree
Refer-To:
<sip:conference666@mrfc1.home1.net;method=BYE>
Referred-By: <sip:user1_public1@home1.net>
Proxy-Require: sec-agree
Security-Verify: ipsec-3gpp; q=0.1; alg=hmac-sha-1-96;
spi-c=98765432; spi-s=87654321; port-c=8642; port-
s=7531
Contact:
<sip:[5555::aaa:bbb:ccc:ddd]:1357;comp=sigcomp>
Content-Length: 0

In particular, the REFER message has a message header field labelled “Refer To”, as defined in [7], and this message header field contains the C-URI and the value “BYE” for a parameter labelled “method”, that is to say that the message header field contains the character string “method=BYE” (see row 13 from table 3).

In step 408, the P-CSCF 402 uses the C-URI indicated in the REFER message (see row 9 from table 3) to forward the REFER message to the S-CSCF 404.

In step 409, the S-CSCF 404 uses the C-URI indicated in the REFER message to forward the REFER message to the application server 406, which provides the focus 421 corresponding to the indicated first C-URI.

In step 410, the focus 421 checks whether the Refer To message header field in the REFER message contains the C-URI and the character string “method=BYE”.

If the Refer To message header field in the REFER message does contain the C-URI and the character string “method=BYE”, the focus 421 terminates the conference corresponding to the C-URI.

In step 411, the focus 421 sends the communication terminal 401 a confirmation of receipt of the REFER message using a “202 Accepted” SIP message, which is transmitted to the S-CSCF 404.

In step 412, the S-CSCF 404 forwards the Accepted message to the P-CSCF 402, which transmits the Accepted message to the communication terminal 401 in step 413.

Since the C-URI and the character string “method=BYE” are contained in the REFER message in this example, the focus terminates the conference in step 414 by terminating the SIP dialogs with all conference participants and releasing the resources engaged for the conference.

In particular, the participation by the user who is using the communication terminal 401 is terminated. For this reason, in step 415 the focus 421 transmits a message labelled “BYE” to the S-CSCF 304 for forwarding to the communication terminal 401.

In step 416, the S-CSCF 404 forwards the BYE message to the P-CSCF 402, which transmits the BYE message to the communication terminal 401 in step 417.

In step 418, the communication terminal confirms receipt of the BYE message by transmitting a message labelled “200 OK” to the P-CSCF 402 for forwarding to the application server 406.

In step 419, the P-CSCF 402 forwards the OK message to the S-CSCF 404, which transmits the OK message to the focus 421 in step 420.

In line with [7], a generic parameter may be used in the Refer To message header field.

In a further embodiment, which is a variant of the embodiment described with reference to FIG. 4, the generic parameter is used to indicate to the focus 421 that the conference referenced by means of the indicated C-URI needs to be terminated.

The flow of messages in the embodiment is similar to the embodiment described with reference to FIG. 4.

However, the REFER message is in the form shown in table 4.

TABLE 4

REFER sip:conference666@mrfc1.home1.net SIP/2.0
Via: SIP/2.0/UDP [5555::aaa:bbb:ccc:ddd]:1357;
comp=sigcomp;branch=z9hG4bKnashds7
Max-Forwards: 70
Route: <sip:pcscf1.visited1.net:7531;lr;comp=sigcomp>,
<sip:orig@scscf1.home1.net;lr>
P-Preferred-Identity: “Holger Schmidt”
<sip:user1_public1@home1.net>
P-Access-Network-Info: 3GPP-UTRAN-FDD;
utran-cell-id-3gpp=234151D0FCE11
Privacy: none
From: <sip:user1_public1@home1.net>; tag=171828
To: < conference666@mrfc1.home1.net>
Call-ID: cb03a0s09a2sdfglkj490333
Cseq: 127 REFER
Require: sec-agree
Refer-To:
<sip:conference666@mrfc1.home1.net;method=BYE;
terminate>
Referred-By: <sip:user1_public1@home1.net>
Proxy-Require: sec-agree
Security-Verify: ipsec-3gpp; q=0.1; alg=hmac-sha-1-96;
spi-c=98765432; spi-s=87654321; port-c=8642; port-
s=7531
Contact:
<sip:[5555::aaa:bbb:ccc:ddd]:1357;comp=sigcomp>
Content-Length: 0

In the variant, however, the generic parameter is additionally set to the value “terminate”, for example (see row 13 in table 4).

The character string “terminate” instructs the conference server to terminate the conference corresponding to the indicated C-URI.

In a further embodiment, the flow of messages is likewise in a similar form to the embodiment described with reference to FIG. 4, but the REFER message is in the form shown in table 5.

TABLE 5

REFER sip:conference666@mrfc1.home1.net SIP/2.0
Via: SIP/2.0/UDP [5555::aaa:bbb:ccc:ddd]:1357;
comp=sigcomp;branch=z9hG4bKnashds7
Max-Forwards: 70
Route: <sip:pcscf1.visited1.net:7531;lr;comp=sigcomp>,
<sip:orig@scscf1.home1.net;lr>
P-Preferred-Identity: “Holger Schmidt”
<sip:user1_public1@home1.net>
P-Access-Network-Info: 3GPP-UTRAN-FDD;
utran-cell-id-3gpp=234151D0FCE11
Privacy: none
From: <sip:user1_public1@home1.net>; tag=171828
To: < conference666@mrfc1.home1.net>
Call-ID: cb03a0s09a2sdfglkj490333
Cseq: 127 REFER
Require: sec-agree
Refer-To:
<sip:*@*;method=BYE >
Referred-By: <sip:user1_public1@home1.net>
Proxy-Require: sec-agree
Security-Verify: ipsec-3gpp; q=0.1; alg=hmac-sha-1-96;
spi-c=98765432; spi-s=87654321; port-c=8642; port-
s=7531
Contact:
<sip:[5555::aaa:bbb:ccc:ddd]:1357;comp=sigcomp>
Content-Length: 0

In particular, “wildcards” are used within the Refer To message header field (see row 13 in table 5).

The wildcard “*@*” references all address ranges.

Wildcards can also be used to reference individual address ranges, for example using “*@t-mobile.de”.

Following receipt of the REFER message, the focus 421 sends all conference participants a BYE message, since the communication terminals of all conference participants are referenced by means of the wildcard *@*.

By transmitting a BYE message to all participants, all participants are removed from the conference, which results in termination of the conference.

This is achieved using a single REFER message sent by the user, as described.

In this way, implicit termination of the conference is achieved using SIP messages.

The following publications have been cited in this document:
[1] IETF SIPPING Working Group: draft-ietf-sipping-conferencing-framework-01
[2] 3GPP TR29.847: Conferencing based on SIP, SDP and other protocols
[3] RFC 3261: SIP: Session Initiation Protocol
[4] IETF SIPPING Working Group: draft-ietf-sipping-cc-conferencing-03
[5] IETF SIP Working Group: draft-ietf-sip-callerprefs-10
[6] IETF SIP Working Group: draft-ietf-sip-callee-caps-03
[7] IETF RF 3515: The SIP Refer Method
[8] 3GPP TS 23.228: IP multimedia subsystem; Stage 2
[9] U.S. Pat. No. 5,737,530
[10] DE 100 30 189 A1

1-18. (canceled)

19. A communication system comprising:
a conference server which provides at least one conference for a plurality of communication terminals;
at least one communication terminal having a message generation unit that generates a session initiation protocol message, which contains control information specifying whether the at least one communication terminal needs to be added to a conference, and/or a conference needs to be created, and/or a conference needs to be terminated, and/or information about the at least one conference provided by the conference server needs to be transmitted to the at least one communication terminal; and
a conference control unit that has an ascertainment apparatus which ascertains the control information from the session initiation protocol message, and has a control apparatus which uses the ascertained control information as a basis for adding the at least one communication terminal to a conference, and/or creating a conference, and/or terminating a conference, and/or transmitting information about at least one of the conferences provided by the conference server to the at least one communication terminal.

20. The communication system as claimed in claim 19, wherein the control information is contained in the session initiation protocol message in a form of a feature tag.

21. The communication system as claimed in claim 20, wherein the communication system is configured in line with a 3GPP standard.

22. The communication system as claimed in claim 21, wherein the feature tag is provided in the IETF standard or 3GPP standard.

23. The communication system as claimed in claim 22, wherein the feature tag is newly defined in comparison with the IETF standard or in comparison with the 3GPP standard.

24. The communication system as claimed in claim 21, wherein the feature tag is contained in a Accept Contact message header field or in a Reject Contact message header field of the session initiation protocol message.

25. The communication system as claimed in claim 19, wherein the control information is contained in the session initiation protocol message in a form of a reference.

26. The communication system as claimed in claim 25, wherein the reference has at least one wildcard.

27. The communication system as claimed in claim 25, wherein the reference has one or more parameter values.

28. The communication system as claimed in claim 25, wherein the communication system is configured in line with a 3GPP standard.

29. The communication system as claimed in claim 28, wherein the reference is contained in a Refer To message header field.

30. The communication system as claimed in claim 19, wherein the session initiation protocol message is configured in line with the H.323 protocol.

31. The communication system as claimed in claim 19, wherein the at least one conference provided by the conference server is a multimedia conference.

32. A method for controlling a communication system having a conference server which provides at least one conference for a plurality of communication terminals, a conference control unit, and at least one communication terminal, the method comprises the steps of:
generating, by the at least one communication terminal, a session initiation protocol message, which contains control information specifying whether the at least one communication terminal needs to be added to a conference, and/or a conference needs to be created, and/or a conference needs to be terminated, and/or information about at least one of the conferences provided by the conference server needs to be transmitted to the at least one communication terminal;
ascertaining, by the conference control unit, the control information from the message; and
using, by the conference control unit, the ascertained control information as a basis for adding the at least one communication terminal to a conference, and/or creating a conference, and/or terminating a conference, and/or transmitting information about at least one of the conferences provided by the conference server to the at least one communication terminal.

33. A communication terminal in a communication system having a conference server which provides at least one conference for a plurality of communication terminals, the communication terminal comprising a message generation unit that generates a session initiation protocol message which contains control information specifying whether the communication terminal needs to be added to a conference, and/or a conference needs to be created, and/or a conference needs to be terminated, and/or information about the at least one conference provided by the conference server needs to be transmitted to the communication terminal.

34. A method for controlling a communication terminal in a communication system having a conference server which provides at least one conference for a plurality of communication terminals, the method comprising the step of generating, by the communication terminal, a session initiation protocol message which contains control information specifying whether the communication terminal needs to be added to a conference, and/or a conference needs to be created, and/or a conference needs to be terminated, and/or information about at least one of the conferences provided by the conference server needs to be transmitted to the communication terminal.

35. A conference control unit in a communication system having at least one communication terminal and a conference server that provides at least one conference for a plurality of communication terminals, the conference control unit comprising:
an ascertainment apparatus which ascertains, from a received message, control information specifying whether the at least one communication terminal needs to be added to a conference, and/or a conference needs to be created, and/or a conference needs to be terminated, and/or information about at least one of the conferences provided by the conference server needs to be transmitted to the at least one communication terminal; and
a control apparatus which uses the ascertained control information as a basis for adding the at least one communication terminal to a conference, and/or creating a conference, and/or terminating a conference, and/or transmitting information about at least one of the conferences provided by the conference server to the at least one communication terminal.

36. A method for controlling a conference control unit in a communication system which has at least one communication terminal and a conference server which provides at least one conference for a plurality of communication terminals, the method comprising the steps of:
ascertaining, by the conference control unit, from a received message, control information specifying whether the at least one communication terminal needs to be added to a conference, and/or a conference needs to be created, and/or a conference needs to be terminated, and/or information about at least one of the conferences provided by the conference server needs to be transmitted to the at least one communication terminal; and
using, by the conference control unit, the ascertained control information as a basis for adding the at least one communication terminal to a conference, and/or creating a conference, and/or terminating a conference, and/or transmitting information about at least one of the conferences provided by the conference server to the at least one communication terminal.
